(19) United States
(12) Patent Application Publication
(10) Pub. No.: US 2009/0177808 A1
(43) Pub. Date: Jul. 9, 2009

(54) Apparatus and methods supporting device triggered disengagement of a hot-swappable serial device by a host system

(75) Inventors: HeeDo Park, Milpitas, CA (US); Edward Lim, Danville, CA (US); SungChang Lee, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO. LTD.

(21) Appl. No.: 12/006,616

(22) Filed: Jan. 3, 2008

(51) Int. Cl. G06F 3/00

(52) U.S. Cl. 710/19

(57) ABSTRACT

A serial device responding to user stimulation of disengagement actuator in the device to post a disengagement request via a serial socket in a host system complying with an insensitive serial protocol. The host system responds to receipt of the disengagement request by disengaging the serial socket with user notification of a safe disengagement message upon the disengagement of the serial socket. The insensitive serial protocol supports hot-swapping without automatic device disengagement, such as USB, FIREWIRE and SATA. Other embodiments include a computer readable media, a download portal as presented by a host system or provided by a server to alter the host system.

### TECHNICAL FIELD

This invention relates to serial protocols supporting hot swapping of serial devices without automatic removal detection.

### BACKGROUND OF THE INVENTION

There are several serial protocols in use in the personal computer environment that can be hot-swapped, meaning serial devices may be removed without turning off the computer. Examples of such serial protocols include various versions of the Universal Serial Bus (USB), the IEEE 1394 (FIREWIRE) and Serial Advanced Technology Attachment (SATA) protocols. While each of these serial protocols is hot swappable, they require that the host system be told that they should disengage and that frequently requires a user to trigger an icon often found in the system tray of a Window interface, making them insensitive serial protocols as used herein. Mechanisms and methods of operation are needed that support the user triggering disengagement from the device itself.

### SUMMARY OF THE INVENTION

One embodiment of the invention operates a serial device responding to stimulation of a disengagement actuator included in the serial device to post a disengagement request via a serial socket included in a host system in compliance with an insensitive serial protocol and/or the host system responding to receipt of the disengagement request by disengaging the serial socket with notification of a safe disengagement message upon the disengagement of the serial socket.

An insensitive serial protocol supports hot swapping of serial devices without automated disengagement detection. Hot swapping a serial device is inserting or removing it without powering down the host system. Examples of the insensitive serial protocol include versions of the Universal Serial Bus (USB) protocol, the IEEE 1394 (FIREWIRE) protocol, and the Serial Advanced Technology Attachment (SATA) disk drive communications protocol.

The host system may respond by initiating a disengagement process for the serial socket and notifying with a safe disengagement message upon completing the disengagement process. Disengagement may flush all ongoing communication and power down the serial socket. Flushing may empty serial device cache(s).

Other embodiments include the serial device with the disengagement actuator, a computer readable medium including a device driver for the serial device, the host system including a device driver and a server system with a download portal for the device driver and/or a device program system for operating a serial device in accord with this invention.

### BRIEF DESCRIPTION OF THE DRAWINGS

FIGS. 1A and 1B show in a schematic fashion an example of the operation a host system coupled through a serial socket to a serial device configured to support an insensitive serial protocol. FIG. 1A shows the serial device responding to a user stimulating a disengagement actuator included in the serial device to post a disengagement request via a serial socket included in a host system in compliance with an insensitive serial protocol. FIG. 1B shows the host system responding to receipt of the disengagement request by disengaging the serial device with notifying the user with a safe disengagement message;

FIG. 2 shows a refinement of FIGS. 1A and 1B where the host system includes a processor coupled via three serial sockets to three serial device, supporting versions of the Universal Serial Bus (USB) protocol, the FIREWIRE protocol and the Serial ATA (SATA) protocol. The first serial device includes a push button as its disengagement actuator. The second serial device includes a pressure switch as its disengagement actuator. And the third serial device may include a fingerprint sensor as its disengagement actuator. The processor may notify with the safe disengagement messages as a window message, as a light indication and/or as an auditory sequence;

FIG. 3 shows a detail of the host system of FIGS. 1A to 2, where the processor is communicatively coupled to a communication component and controllably coupled to a power component, both of the host socket complying with the insensitive serial protocol. The processor is shown including at least one instance of at least one controller that includes a computer directed by a device driver including at least one program step residing in a computer readable medium;

FIGS. 4 and 5 include flowcharts showing some of the details of the device driver of FIG. 3. FIG. 4 shows the device driver responding to receipt of the disengagement request by disengaging the serial device with notification of a safe disengagement message. FIG. 5 shows some details of FIG. 4 by initiating a disengagement process for the serial socket and notifying the user with a safe disengagement message upon completing the disengagement process;

FIG. 6 shows some schematic details of the serial devices of FIGS. 1 to 2, where the serial device includes at least one device controller that further includes a device computer directed by a device program system residing in a device computer readable memory;

FIG. 7 shows some details of the device program system of FIG. 6 directing the device computer to respond to stimulation of the disengagement actuator by posting the disengagement request;

FIG. 8 shows a simplified directory of a computer readable memory including at least one of the device driver and an installation package of the device driver and/or a component of an operating system using the device driver to operate at least one example of the serial devices; and

FIG. 9 shows a block diagram of a download portal for the device driver and/or the installation package of FIG. 8 as may be presented by the host system and/or provided by a server.

### DETAILED DESCRIPTION

This invention relates to a serial device including a disengagement actuator on a serial device that signals using an insensitive serial protocol to communicate a disengagement request to a host system. The serial host recognizes the disengagement request and disengages the serial device in compliance with the insensitive serial protocol, where the protocol supports hot swapping serial devices without automatic removal detection. A serial protocol as used herein communicates a single bit at a time, communicating data serially or sequentially one bit at a time. A serial device as used herein uses a serial protocol for communication.

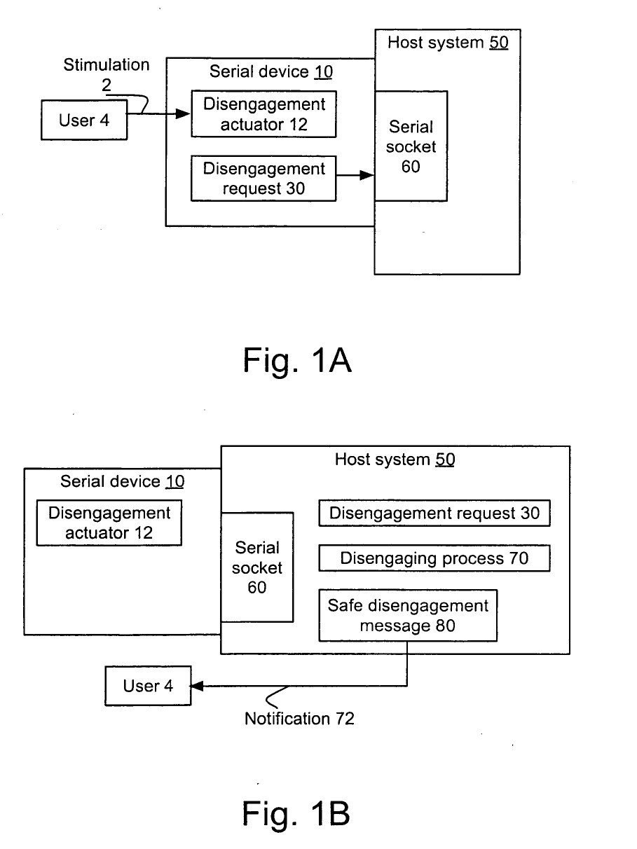

Referring to the drawings more particularly by reference numbers, FIGS. 1A and 1B show in a schematic fashion an example of the operation a host system 50 coupled through a serial socket 60 to a serial device 10 configured to support an insensitive serial protocol. FIG. 1A shows the serial device responding to a user 4 stimulating 2 a disengagement actuator 12 included in the serial device to post a disengagement request 30 via the serial socket to the host system.

FIG. 1B shows the host system 50 responding to receipt of the disengagement request 30 by disengaging 70 the serial socket 60 with notification 72 of a safe disengagement message 80 to the user 4 upon disengaging the serial socket. The host system may disengage the serial socket by flushing all ongoing communication and powering down the serial socket. Flushing may empty cache(s), particularly write caches in the serial device 10.

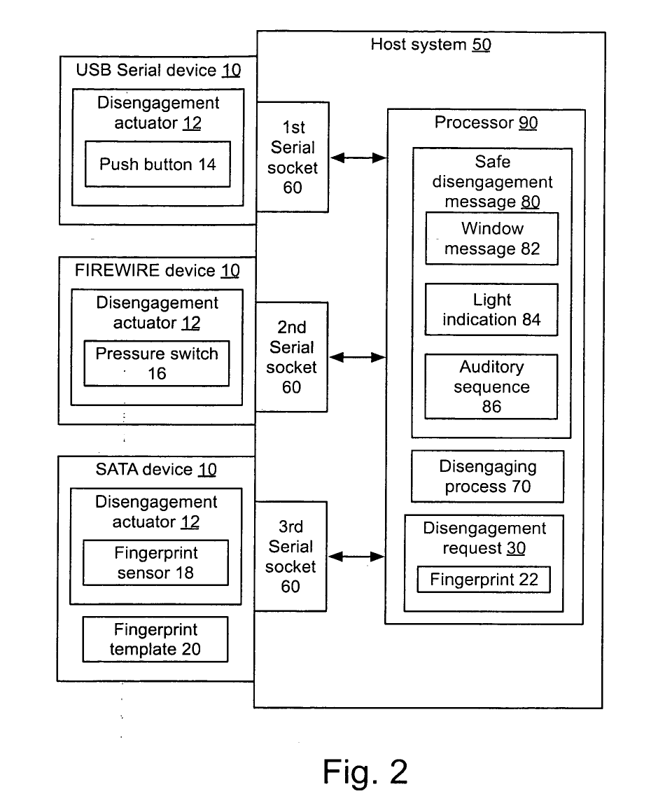

FIG. 2 shows a refinement of FIGS. 1A and 1B where the host system 50 includes a processor 90 coupled via three serial sockets 60 to three serial devices 10, respectively supporting versions of the Universal Serial Bus (USB) protocol, the FIREWIRE protocol and the Serial ATA (SATA) protocol. The first serial device includes a push button 14 as its disengagement actuator 12. The second serial device includes a pressure switch 16 as its disengagement actuator. And the third serial device may include a fingerprint sensor 18 as its disengagement actuator. The third serial device may include a fingerprint template 20 that may be used to authorize the disengagement request based upon a fingerprint 22 created by the fingerprint sensor. The disengagement request may include the fingerprint as shown. In certain embodiments, the host system may grant or block disengagement based upon the received fingerprint. The host system may record the finger print, possibly with a time stamp.

The processor 90 may notify 72 the user as shown in FIG. 1A with the safe disengagement message 80 as a window message 82, as a light indication 84 and/or as an auditory sequence 88. The window message may be displayed on a screen with or without the host system supporting a windowing operating system. The light indication may use a light indicator possibly illuminating an icon. The auditory sequence may be a tone, a sequence of tones, a melody and/or speak a sequence of syllables such as “You may remove the device now”.

The USB protocol refers to a version of the USB protocol standardized by the USB Implementer Forum (USB-IF). The FIREWIRE protocol is Apple's brand name for the Institute for Electrical and Electronic Engineers (IEEE) standards 1394 interface. The Serial Advanced Technology Attachment (SATA) is an international standard under the supervision of the Serial ATA International Organization (SATA-IO) (http://www.sata-io.org/).

The serial device 10 may include but is not limited to a disk drive, a media player, a mouse device, a keyboard, a Personal Digital Assistant (PDA), a game pad, a joystick, a scanner, a digital camera, a video camera and/or a printer. The disk drive may include a removable media disk drive, an optical disk drive, a ferromagnetic disk drive and/or a ferroelectric disk drive.

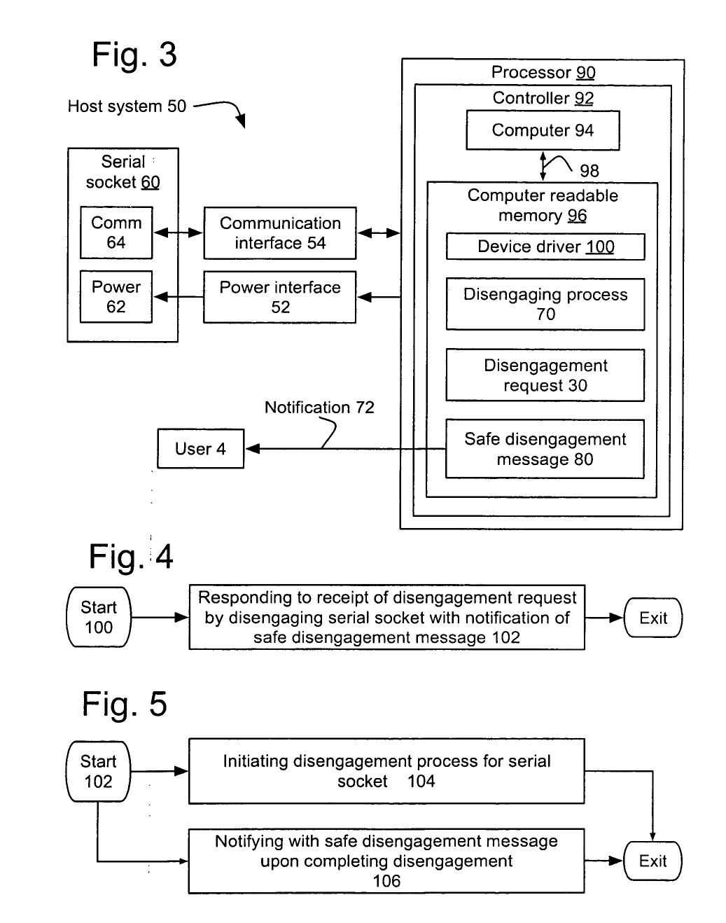

The processor 90 may include at least one instance of at least one controller 92 as shown in FIG. 3, where each controller receives at least one input, maintains and updates at least one state and generates at least one output based upon the value of at least one of the inputs and/or the states. In certain embodiments of the invention, a controller may include a finite state machine and/or a computer 94 directed by a device driver 100 including at least one program step residing in a computer readable medium 96 accessibly coupled via a bus with the computer.

The computer 94 may include at least one data processor and at least one instruction processor instructed by the device driver 100 as disclosed herein. Each of the data processors may be instructed by at least one of the instruction processors.

FIG. 3 shows a detail of the host system 50 of FIGS. 1A to 2, where the processor 90 is communicatively coupled via a communications interface 54 to a communication component 64 and controllably coupled via a power interface 52 to a power component 62, where both the communications component and the power component are included in the serial socket 60 complying with one of the insensitive serial protocols. The processor is shown including at least one instance of at least one controller 92 that includes a computer 94 directed by a device driver 100 including at least one program step residing in a computer readable medium 96 that is accessibly coupled 98 preferably via a bus. The processor preferably notifies 72 the user 4 with the safe disengagement message 80.

Note that program steps included in a device driver and/or a program system may represent the actions of various states of the finite state machine or at least partly direct actions of a computer. A memory may include a non-volatile memory component and/or a volatile memory component. As used herein, a non-volatile memory component retains its memory state without required power and a volatile memory component tends to lose its memory state without at least occasionally being supplied power. Starting a flowchart may involve initial a state sequence in a finite state machine and/or entry into a subroutine or instruction sequence in a program system. Exiting a flowchart may involve completing the state sequence in the finite state machine and/or returning from a subroutine in the computer.

FIGS. 4 and 5 include flowcharts showing some details of the device driver 100 and of the operation of the host system 50 of FIG. 3. FIG. 4 shows device driver including the program step 102 supporting the host system 50 responding to receipt of the disengagement request 30 by disengaging 70 the serial socket 60 with notification 72 of a safe disengagement message. The disengaging process 70 may include controlling a power interface 52 of FIG. 3 to disengage the power component 62 of the serial socket 60, and communicating with the communications interface 54 to disengage the communications component 64 of the serial socket. Preferably, the communications is disengaged before the power. The serial device may include a write cache, which is flushed as part of disengaging the communications component. FIG. 5 shows some details of program step 102 of FIG. 4 including program step 104 initiating a disengagement process 70 for the serial socket and program step 106 notifying 72 the user 4 with the safe disengagement message 80 upon completing the disengagement process.

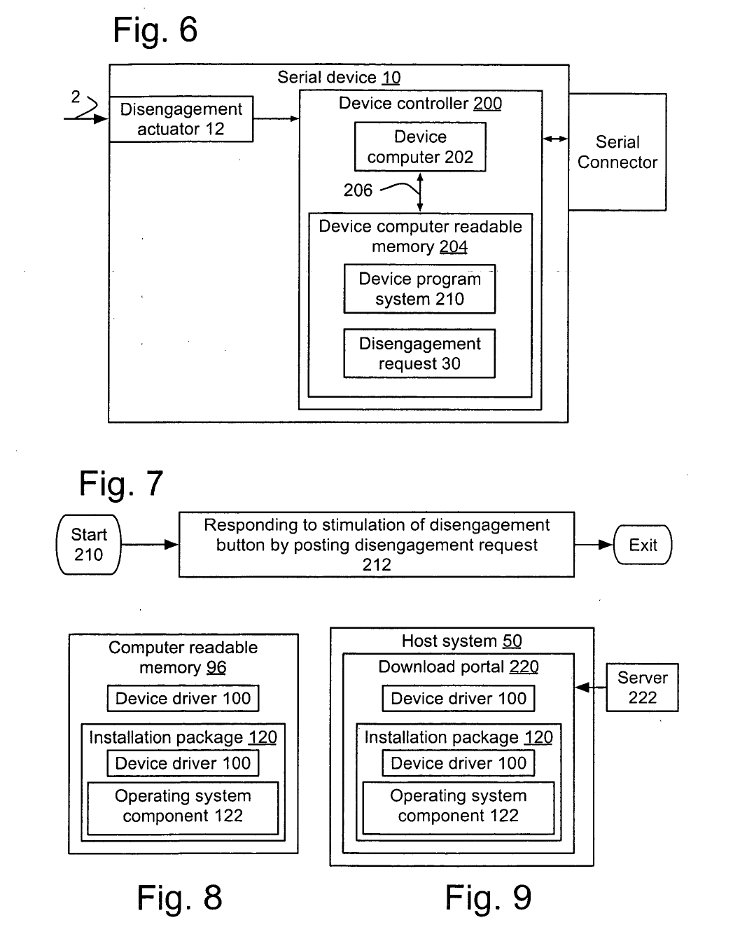

FIG. 6 shows some schematic details of the serial device 10 of FIGS. 1A to 2, where the serial device includes at least one device controller 200 that further includes a device computer 202 directed by a device program system 210 residing in a device computer readable memory 204. The serial connector is preferably compatible with the serial socket 60 for at least one of the insensitive serial protocols.

FIG. 7 shows some details of the device program system 210 of FIG. 6 directing the device computer 202 to respond to stimulation 2 of the disengagement actuator 12 by posting the disengagement request 30.

FIG. 8 shows a simplified directory of a computer readable memory 96 including the device driver 100 and/or an installation package 120. The installation package may support installing the device driver and/or an operating system component 122 using the device driver to operate at least one example of the serial devices 10.

The component 122 of an operating system uses the device driver 100 to operate at least one of the serial devices 10 in accord with the invention. The operating system may be a windowing operating system or a real-time operating system. Examples of a windowing operating system include windowing operating systems manufactured by the Microsoft Corporation and windowing operating systems used by companies such as the Apple Corporation and Sun Microsystems. As used herein a real-time operating system may support display screens, but not have inherent libraries for windows within display screens, as is often found in handheld devices such as cellular telephones and some PDAs.

FIG. 9 shows a block diagram of a download portal 220 including a mechanism to download the device driver 100 and/or the installation package 120 FIG. 8, which may be presented on the host system 50 and may be provided by a server 222, possibly across a network with wireline and/or wireless communication links between the host system and the server. The download mechanism of the server providing the download portal may alter the host system operation the serial socket to respond to the disengagement request 30 by disengaging 70 the serial socket while complying with the insensitive serial protocol.

The preceding embodiments provide examples of the invention and are not meant to constrain the scope of the following claims.

What is claimed is:

1. A method, comprising the step of:
responding by a serial device to stimulation by the user of a disengagement actuator to post a disengagement request in compliance with an insensitive serial protocol,
whereby said serial device includes a disengagement actuator, and
said disengagement request is posted via a serial socket included in a host system in compliance with said insensitive serial protocol.

2. The method of claim 1, wherein said insensitive serial protocol is one of a version of a Universal Serial Bus (USB) protocol, a version of an Institute for Electrical and Electronic Engineers (IEEE) 1394 serial protocol, and a version of a Serial Advanced Technology Attachment (SATA) protocol.

3. The method of claim 1, further comprising the step of:
responding by a host system to receipt of said disengagement request via said serial socket included in said host system by disengaging said serial device in compliance with said insensitive serial protocol.

4. The method of claim 3, wherein the step responding said host system, further comprises the steps of:
responding by said host system to receipt of said disengagement request by initiating a disengagement process for said serial socket; and
notifying the user with a safe disengagement message after completing said disengagement process.

5. A serial device, comprising:
a socket component including a power component and a serial component, both complying with an insensitive serial protocol;
a disengagement actuator; and
a processor communicatively coupled to said disengagement actuator and communicatively coupled to a serial component of said socket component, wherein said processor is configured to respond to stimulation of said disengagement actuator by creating a disengagement request posted for communication via said serial component using said insensitive serial protocol.

6. The serial device of claim 5, wherein said insensitive serial protocol is one of a version of a Universal Serial Bus (USB) protocol, a version of an Institute for Electrical and Electronic Engineers (IEEE) 1394 serial protocol, and a version of a Serial Advanced Technology Attachment (SATA) protocol.

7. The serial device of claim 5, wherein said disengagement actuator includes at least one of a push button, a pressure switch, and a fingerprint sensor.

8. The serial device of claim 5, wherein said processor includes at least one instance of at least one device controller, whereby said device controller receives at least one input, maintains and updates at least one state based upon a value at least one of said inputs, and outputs at least one output based upon said value of at least one member of the group consisting of said inputs and said states.

9. The serial device of claim 8, wherein at least one of said instances of said device controller includes at least one member of the group consisting of a finite state machine and a computer.

10. The serial device of claim 9, wherein said program system includes the program step of:
responding to said stimulation of said disengagement actuator by creating a disengagement request posted for communication via said serial component using said insensitive serial protocol.

11. A method, comprising the step of:
responding by a host system to receipt of a disengagement request via a serial socket included in said host system by disengaging said serial device in compliance with an insensitive serial protocol.

12. The method of claim 11, wherein said insensitive serial protocol is one of a version of a Universal Serial Bus (USB) protocol, a version of an Institute for Electrical and Electronic Engineers (IEEE) 1394 serial protocol, and a version of a Serial Advanced Technology Attachment (SATA) protocol.

13. The method of claim 1 1, wherein the step responding by said host system, further comprises the steps of:
responding by said host system to receipt of said disengagement request by initiating a disengagement process for said serial socket; and
notifying the user with a safe disengagement message after completing said disengagement process.

14. A host system, comprising:
a processor communicatively and controllably coupled to a serial socket complying with an insensitive serial protocol,
whereby said processor is configured to respond to a disengagement message by disengaging said serial socket and notify the user with a safe disengagement message after disengagement of said serial socket.

15. The host system of claim 14, wherein said insensitive serial protocol is one of a version of a Universal Serial Bus (USB) protocol, a version of an Institute for Electrical and Electronic Engineers (IEEE) 1394 serial protocol, and a version of a Serial Advanced Technology Attachment (SATA) protocol.

16. The host system of claim 14, wherein said safe disengagement message may include at least one of a window message, a light indication, and an auditory sequence.

17. The host system of claim 14, wherein said host processor includes at least one instance of at least one controller, said instances including at least one member of the group consisting of a finite state machine and a computer directed by a device driver including program steps residing in a computer readable memory.

18. The host system of claim 17, wherein said device driver includes the program steps of:
responding to a safe disengagement message by initiating a disengagement process; and
responding to completion of said disengagement process by notifying with said safe disengagement message.

19. The host system of claim 18, wherein said disengagement process includes disengaging ongoing communications using said communication component followed by disengaging power to said power component.

20. A computer readable memory, comprising:
a device driver for a host system operating a serial socket directing said host system to respond to a safe disengagement message by disengaging said serial socket in compliance with a insensitive serial protocol,
whereby said insensitive serial protocol is a hot swappable serial protocol without automated disengagement.

21. The computer readable memory of claim 20, further comprising an installation package for said device driver.

22. The computer readable memory of claim 20, further comprising an installation package for a component of an operating system using said device driver to operate a serial device.
